(19) United States
(12) Patent Application Publication
(10) Pub. No.: US 2026/0108910 A1
(43) Pub. Date: Apr. 23, 2026

(54) CURING APPARATUS AND METHOD OF CURING USING THE SAME

(71) Applicant: SAMSUNG DISPLAY CO., LTD., YONGIN-SI (KR)

(72) Inventor: JAEGI YOO, Yongin-si (KR)

(21) Appl. No.: 19/243,062

(22) Filed: Jun. 19, 2025

(30) Foreign Application Priority Data
Oct. 22, 2024 (KR) 10-2024-0144771

(51) Int. Cl. B05D 3/06; B41F 23/04

(52) U.S. Cl. CPC B05D 3/067; B41F 23/0486

(57) ABSTRACT

A curing apparatus includes a curing device configured to emit an ultraviolet (UV) light in a first direction, a first film disposed under the curing device and configured to block a first part of the UV light emitted by the curing device, a second film disposed under the curing device, configured to block a second part of the UV light emitted by the curing device, and spaced apart from the first film in a second direction intersecting the first direction, a first motor configured to move the first film in the second direction, and a second motor configured to move the second film in a direction opposite to the second direction.

### CROSS-REFERENCE TO RELATED APPLICATIONS

This application claims priority under 35 U.S.C. § 119 to Korean Patent Application No. 10-2024-0144771, filed on October 22, 2024, the disclosure of which is herein incorporated by reference herein in its entirety.

### TECHNICAL FIELD

Embodiments of the present disclosure relate to a curing apparatus and a method of curing using the same. More specifically, embodiments of the present disclosure relate to a curing apparatus that may prevent light leakage of a display device and a method of curing using the same.

### DISCUSSION OF RELATED ART

A display device may include a display area and a peripheral area. Reducing light emission from the peripheral area may improve display quality of the display device. To prevent light emission from the peripheral area, ink or the like serving as a light leakage prevention material may be disposed on one side of the peripheral area.

However, when ink or the like is disposed on the peripheral area and then cured using ultraviolet (UV) light, damage may occur to a stage or other components on which the display device is placed due to the UV light. To address this issue, a film or membrane that blocks UV light may be placed in the path of the UV light.

### SUMMARY

Embodiments of the present disclosure provide a curing apparatus that improves process efficiency, and a method of curing using the curing apparatus.

According to an embodiment of the present disclosure, a curing apparatus includes a curing device configured to emit an ultraviolet (UV) light in a first direction, a first film disposed under the curing device and configured to block a first part of the UV light emitted by the curing device, a second film disposed under the curing device, configured to block a second part of the UV light emitted by the curing device, and spaced apart from the first film in a second direction intersecting the first direction, a first motor configured to move the first film in the second direction, and a second motor configured to move the second film in a direction opposite to the second direction.

In an embodiment, the curing apparatus further includes a first reel connected to the first film and a second reel connected to the second film.

In an embodiment, the curing apparatus further includes a first spiral spring disposed inside the first reel and configured to pull the first film in the direction opposite to the second direction and a second spiral spring disposed inside the second reel and configured to pull the second film in the second direction.

In an embodiment, the curing apparatus further includes a third motor disposed inside the first reel and configured to pull the first film in the direction opposite to the second direction and a fourth motor disposed inside the second reel and configured to pull the second film in the second direction.

In an embodiment, the first motor includes a first actuator extending in the second direction and the second motor includes a second actuator extending in the direction opposite to the second direction.

In an embodiment, one end of the first film is connected to the first actuator with a first fixing portion and one end of the second film is connected to the second actuator with a second fixing portion.

In an embodiment, another end of the first film, opposite to the one end of the first film, is wound on the first reel, and another end of the second film, opposite to the one end of the second film, is wound on the second reel.

In an embodiment, a wavelength of the UV light emitted by the curing device is between about 340 nm and about 390 nm.

In an embodiment, each of the first film and the second film includes polyethylene terephthalate (PET).

In an embodiment, the curing apparatus further includes a stage disposed under the curing device and configured to accommodate a display device, and an upper surface of the stage is coated with an anodized coating layer.

According to an embodiment of the present disclosure, a curing apparatus includes a curing device configured to emit a UV light in a first direction, a first film disposed under the curing device and configured to block a first part of the UV light emitted by the curing device, a second film disposed under the curing device, configured to block a second part of the UV light emitted by the curing device, and spaced apart from the first film in a second direction intersecting the first direction, and a guide bar extending in the second direction and including a guide pin having a first fastening portion attached to the first film and a second fastening portion attached to the second film.

In an embodiment, the curing apparatus further includes a first reel connected to the first film and a second reel connected to the second film.

In an embodiment, the curing apparatus further includes a first spiral spring disposed inside the first reel and configured to pull the first film in a direction opposite to the second direction and a second spiral spring disposed inside the second reel and configured to pull the second film in the second direction.

In an embodiment, the curing apparatus further includes a third motor disposed inside the first reel and configured to pull the first film in a direction opposite to the second direction and a second motor disposed inside the second reel and configured to pull the second film in the second direction.

According to an embodiment of the present application, a method of curing ink includes applying the ink to one side of a display device disposed on a stage spaced apart from a curing device in a first direction, expanding a first film in a second direction intersecting the first direction and expanding a second film in a direction opposite to the second direction, and curing the ink by emitting an ultraviolet (UV) light in the first direction from the curing device to cure the ink.

In an embodiment, expanding the first film and the second film includes expanding the first film, by a first actuator connected to the first film and extending in the second direction, under control of a first motor, and expanding the second film, by a second actuator connected to the second film and extending in a direction opposite to the second direction, under control of a second motor.

In an embodiment, during expanding the first film and the second film, each of the first film and the second film is expanded at a speed between about 90 mm/s and about 110 mm/s.

In an embodiment, expanding the first film and the second film is performed within about 2 seconds.

In an embodiment, after expanding the first film and the second film, a first length corresponding to a minimum distance between the first film and the second film in the second direction is greater than a second length corresponding to a length of the ink applied to the display device along a major axis in the second direction.

In an embodiment, the method further includes providing an alarm to a user when a distance between the first film and the second film in the second direction differs from a predetermined distance.

A curing apparatus according to an embodiment of the present disclosure may include a curing device emitting UV light in a first direction, a first film disposed under the curing device and blocking part of the UV light emitted by the curing device, a second film disposed under the curing device, blocking part of the UV light emitted by the curing device, and spaced apart from the first film in a second direction intersecting the first direction, a first motor moving the first film in the second direction, and a second motor moving the second film in a direction opposite to the second direction.

Accordingly, by expanding the first film and the second film by each of the first motor and the second motor, the time taken for curing the display device using the curing device may be reduced. As a result, as the first film and the second film are automatically expanded by the first motor and the second motor, which are mechanical devices, process efficiency by the curing device may be increased. In addition, the stage may be prevented from being damaged by UV light by blocking part of the UV light with the first film and the second film (or damage may be reduced).

### BRIEF DESCRIPTION OF THE DRAWINGS

The above and other features of the present disclosure will become more apparent by describing in detail embodiments thereof with reference to the accompanying drawings.

FIG. 1 is a block diagram showing a curing device according to an embodiment of the present disclosure.

FIG. 2 is a perspective view showing a curing apparatus according to an embodiment of the present disclosure.

FIG. 3 is a plan view showing an embodiment of the curing apparatus of FIG. 2.

FIG. 4 is a perspective view showing an embodiment in which first and second films are expanded in the curing apparatus of FIG. 2.

FIG. 5 is a plan view showing an embodiment of the curing apparatus of FIG. 4.

FIG. 6 is a perspective view showing an embodiment in which the first and second films are wound in the curing apparatus of FIG. 2.

FIG. 7 is a plan view showing an embodiment of the curing apparatus of FIG. 6.

FIG. 8 is a cross-sectional view showing an embodiment of a first spiral spring disposed inside the first reel of FIG. 2.

FIG. 9 is a cross-sectional view showing an embodiment of a third motor disposed inside the first reel of FIG. 2.

FIG. 10 is a cross-sectional view showing an embodiment of curing ink through the curing device of FIG. 4.

FIG. 11 is a cross-sectional view showing an embodiment of a display panel of FIG. 10.

FIGS. 12, 13, 14, and 15 are views showing a method of curing using the curing apparatus according to embodiments of the present disclosure.

FIG. 16 is a perspective view showing a curing apparatus according to an embodiment of the present disclosure.

FIG. 17 is a perspective view showing an embodiment in which the first and second films are expanded in the curing apparatus of FIG. 15.

### DETAILED DESCRIPTION

Embodiments of the present disclosure will be described more fully hereinafter with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

Spatially relative terms, such as “beneath”, “below”, “lower”, “under”, “above”, “upper”, etc., may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below.

It will be understood that when a component is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. It will also be understood that when a component is referred to as “covering” another component, it can be the only component covering the other component, or one or more intervening components may also be covering the other component. Other words used to describe the relationships between components should be interpreted in a like fashion.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art, for example, within ± 30%, 20%, 10% or 5% of the stated value. Further, it is to be understood that while parameters may be described herein as having “about” a certain value, according to embodiments, the parameter may be exactly the certain value or approximately the certain value within a measurement error as would be understood by a person having ordinary skill in the art. Other uses of these terms and similar terms to describe the relationships between components should be interpreted in a like fashion.

As used herein, the singular forms “a,” “an” and “the” are intended to include plural forms as well, unless the context clearly indicates otherwise.

It will be further understood that the terms “comprises” and/or “comprising,” when used in this specification, specify a presence of stated features, integers, steps, operations, elements, and/or components, but do not preclude the presence or addition of one or more other features, integers, steps, operations, elements, components, and/or groups thereof.

Referring to a comparative example, when ultraviolet (UV) light is used to selectively cure ink applied to a display device, a film or membrane is often positioned to block portions of the UV light. However, expanding or adjusting such a film manually can be time-consuming and labor-intensive, thus reducing process efficiency. For example, in a comparative example, the manual expansion of a UV-blocking film during a curing operation may take several minutes, introducing delays in high-throughput manufacturing environments and increasing variability in positioning accuracy.

To address the above issues, embodiments of the present disclosure provide a curing apparatus and method that enable selective and efficient UV curing using automatically expandable UV-blocking films. The curing apparatus may include a UV light source and a pair of films disposed between the curing device and a display device. These films may be automatically expanded in opposite directions to define a controllable exposure window through which UV light is directed. This configuration allows only the target region – such as, for example, light-blocking ink on a peripheral area of the display device – to be irradiated and cured, while protecting surrounding structures like the stage or anodized coating layer from unwanted exposure.

According to embodiments of the present application, the films may be expanded automatically by motors and actuators under the control of a controller, enabling fast, repeatable, and precise operation. In some embodiments, the films may be fixed in place using guide pins arranged along guide bars, offering a simplified yet reliable setup. Embodiments of the present application therefore provide an apparatus and method that may improve curing accuracy and process efficiency, reducing setup time and improving efficiency and precision.

In this specification, a plane may be defined by a first direction D1 and a second direction D2 that intersects the first direction D1. For example, the second direction D2 may be perpendicular to the first direction D1. In addition, a third direction D3 may be a normal direction of the plane. That is, the third direction D3 may be perpendicular to the plane formed by the first direction D1 and the second direction D2.

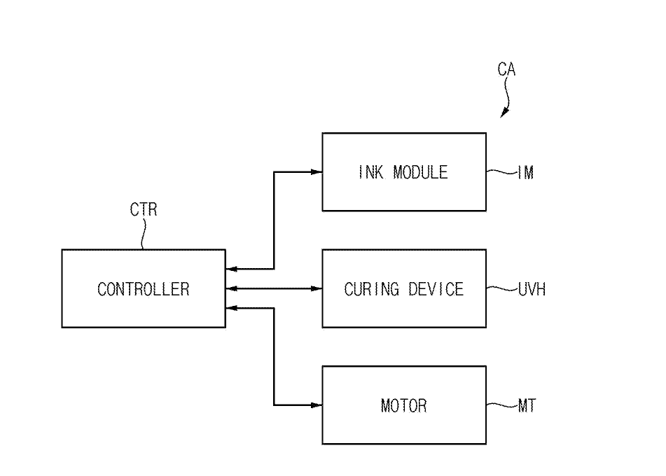

FIG. 1 is a block diagram showing a curing device according to an embodiment of the present disclosure.

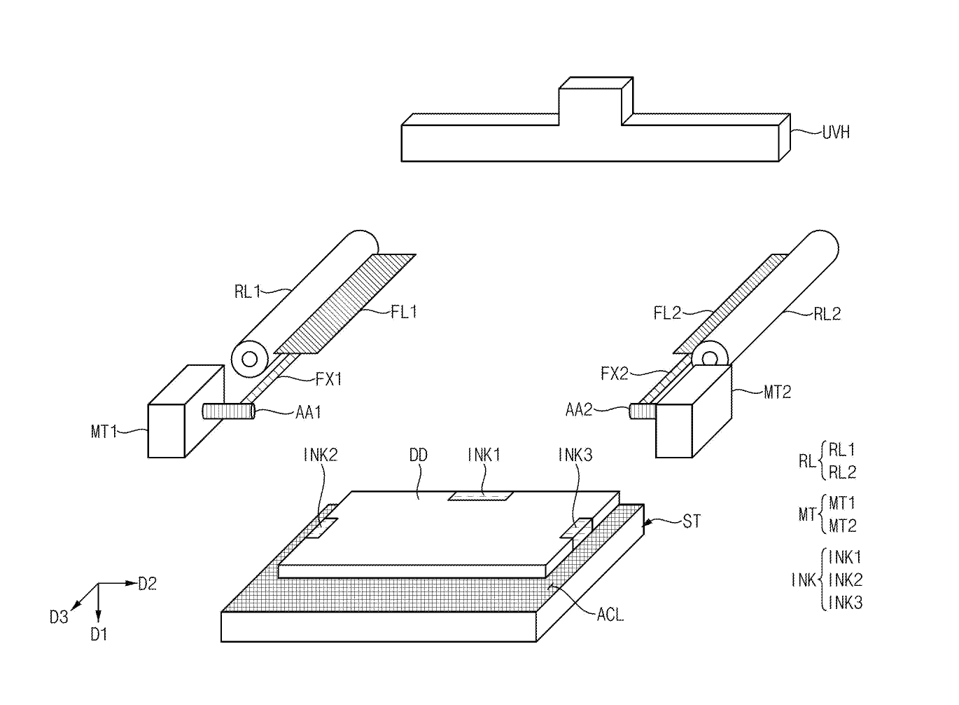

Referring to FIG. 1, a curing apparatus CA may include a controller CTR, an ink module IM, a curing device UVH, and a motor MT. Configurations of the curing apparatus CA shown in FIG. 1 are not necessarily limited thereto. For example, as described further below with reference to FIG. 2, the curing apparatus CA may further include additional configurations.

The controller CTR of the curing device UVH may control each of the ink module IM, the curing device UVH, and the motor MT. In addition, the controller CTR may provide information regarding a curing status to a user.

For example, the controller CTR may control the ink module IM to apply ink (e.g., the ink of FIG. 2) onto a display device DD (e.g., the display device of FIG. 2). The ink INK applied to the display device DD may be cured by the curing device UVH.

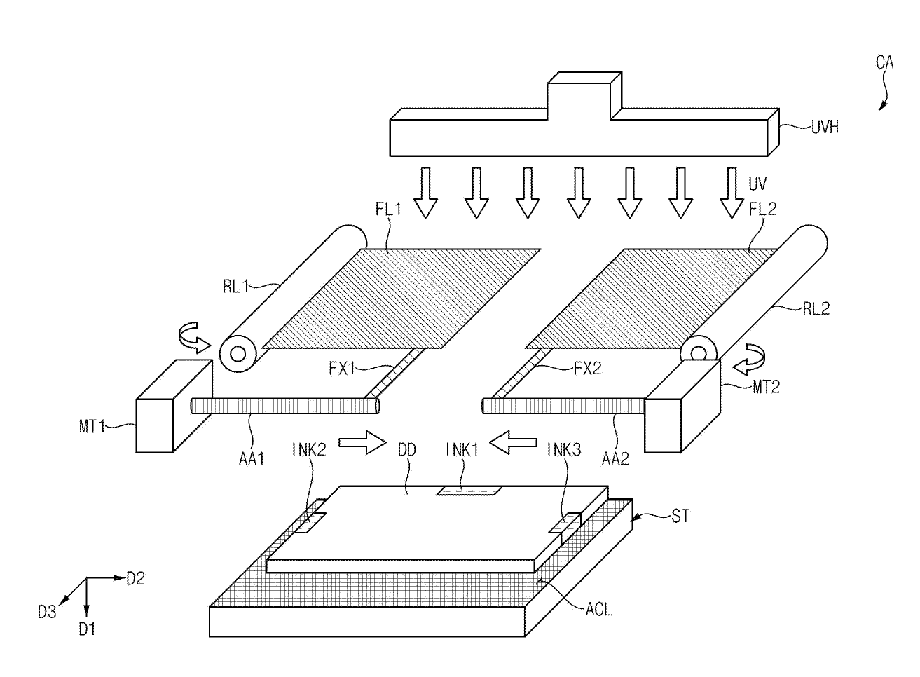

The controller CTR may control the curing device UVH to adjust a curing intensity, curing area, and/or curing duration. The controller CTR may also control the motor MT to adjust the curing area of the UV light (e.g., the UV light UV of FIG. 4) emitted by the curing device UVH. An embodiment in which the controller CTR adjusts the curing area by controlling the motor MT will be described further below with reference to FIGS. 2, 3, 4, 5, 6, and FIG. 7.

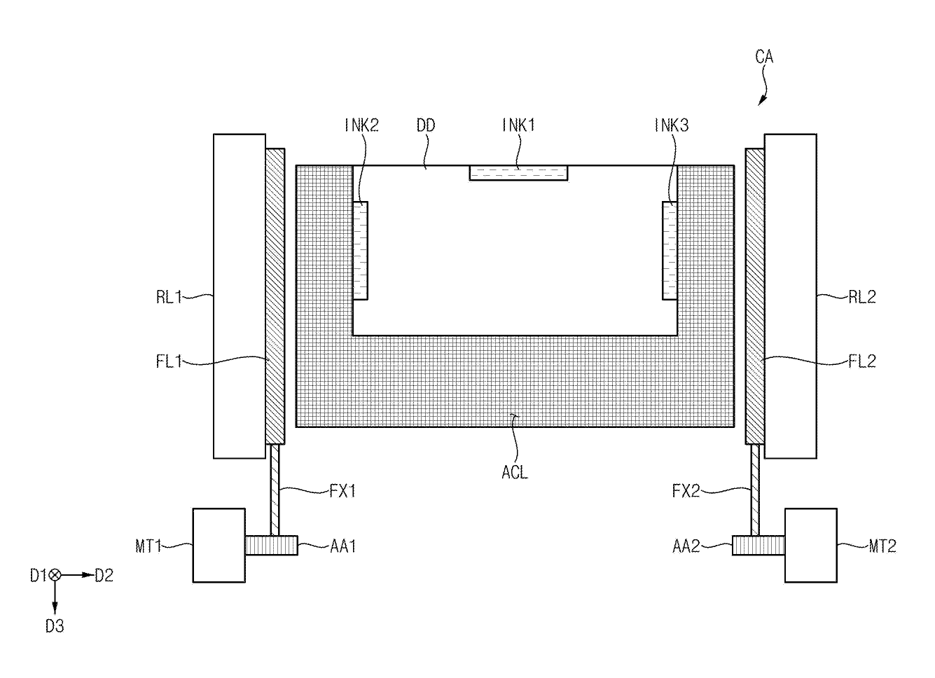

FIG. 2 is a perspective view showing a curing apparatus according to an embodiment of the present disclosure. FIG. 3 is a plan view showing an embodiment of the curing apparatus of FIG. 2. For example, FIGS. 2 and 3 show a state of the curing apparatus CA before the first film FL1 and the second film FL2 are expanded.

Referring to FIGS. 2 and 3, the curing apparatus CA may include the curing device UVH, reels RL, the motor MT, a fixing portion FX, and a stage ST. The reels RL may include a first reel RL1 and a second reel RL2. The motor MT may include a first motor MT1 and a second motor MT2. The fixing portion FX may include a first fixing portion FX1 and a second fixing portion FX2.

The curing device UVH may be disposed on the stage ST. For example, the curing device UVH may be spaced apart from the stage ST in a direction opposite to the first direction D1. The curing device UVH may have a bar shape extending in the second direction D2. However, embodiments of the present disclosure are not limited thereto.

The curing device UVH may cure an ink INK applied to a side of the display device DD. For example, the curing device UVH may cure the ink INK by irradiating the ink INK with UV light (e.g., the UV light UV of FIG. 4).

In an embodiment, a wavelength of the UV light (e.g., the UV light UV of FIG. 4) may be about 340 nm to about 390 nm. For example, the wavelength of the UV light UV may be about 350 nm to about 380 nm. By having a wavelength within this range, the ink INK may be cured by the UV light UV.

The reels RL may be disposed under the curing device UVH. For example, the first reel RL1 may be disposed under the curing device UVH and spaced apart from the curing device UVH in a direction opposite to the second direction D2 in a plan view. The second reel RL2 may be disposed under the curing device UVH and spaced apart from the curing device UVH in the second direction D2 in a plan view. That is, the first reel RL1 and the second reel RL2 may be spaced apart from each other in the second direction D2 in a plan view.

The first reel RL1 and the second reel RL2 may include a first film FL1 and a second film FL2, respectively. For example, the first reel RL1 may include the first film FL1, and the second reel RL2 may include the second film FL2. Before being expanded, the first film FL1 and the second film FL2 may be wound around the first reel RL1 and the second reel RL2, respectively.

In an embodiment, the first film FL1 and the second film FL2 may include a flexible material. Thus, the first film FL1 and the second film FL2 may be wound around the first reel RL1 and the second reel RL2, respectively. For example, each of the first film FL1 and the second film FL2 may include materials such as polyethylene terephthalate, polyimide, polycarbonate, polyamide, triacetyl cellulose, and polymethyl methacrylate. These may be used alone or in combination with each other. However, embodiments of the present disclosure are not limited thereto. The first film FL1 and the second film FL2 may be polarizing films that block UV light (e.g., the UV light UV of FIG. 4).

The motor MT may be disposed under the curing device UVH. For example, the first motor MT1 may be disposed under the curing device UVH and spaced apart from the curing device UVH in a direction opposite to the second direction D2 in a plan view and from the first reel RL1 in the third direction D3. Similarly, the second motor MT2 may be disposed under the curing device UVH and spaced apart from the curing device UVH in the second direction D2 and from the second reel RL2 in the third direction D3. Thus, the first motor MT1 and the second motor MT2 may be spaced apart from each other in the second direction D2.

For example, as shown in FIGS. 2 and 3, according to an embodiment of the present disclosure, the motor MT may be positioned below the curing device UVH. For example, the first motor MT1 may be arranged on a side opposite to the second direction D2 relative to the curing device UVH in a plan view, and located adjacent to the first reel RL1 in the third direction D3. Similarly, the second motor MT2 may be positioned on the side of the curing device UVH corresponding to the second direction D2 in a plan view, and disposed adjacent to the second reel RL2 in the third direction D3. Accordingly, the first motor MT1 and the second motor MT2 may be located apart from one another along the second direction D2.

The first motor MT1 and the second motor MT2 may include a first actuator AA1 and a second actuator AA2, respectively. The first actuator AA1 may extend in the second direction D2, and the second actuator AA2 may extend in a direction opposite to the second direction D2. However, embodiments of the present disclosure are not limited thereto. The first actuator AA1 may extend in the second direction D2 and retract in a direction opposite to the second direction D2. The second actuator AA2 may extend in a direction opposite to the second direction D2 and retract in the second direction D2. Thus, each of the first actuator AA1 and the second actuator AA2 may move linearly in a reciprocating manner in the second direction D2.

The first film FL1 and the first actuator AA1 may be connected by the first fixing portion FX1. As the first film FL1 is connected to the first actuator AA1 by the first fixing portion FX1, the first film FL1 may be expanded in the second direction D2 and rewound around the first reel RL1 in a direction opposite to the second direction D2.

The second film FL2 and the second actuator AA2 may be connected by the second fixing portion FX2. As the second film FL2 is connected to the second actuator AA2 by the second fixing portion FX2, the second film FL2 may be expanded in a direction opposite to the second direction D2 and rewound around the second reel RL2 in the second direction D2.

The stage ST may be disposed under the curing device UVH. As shown in FIG. 2, the stage ST may have a rectangular shape in a plan view. However, embodiments of the present disclosure are not limited thereto. The stage ST may be sufficient to accommodate the display device DD and have various shapes in a plan view, such as, for example, polygonal or circular shapes.

An anodized coating layer ACL may be disposed on an upper surface of the stage ST. That is, an upper surface of the stage ST may be anodized. The anodized coating layer ACL may provide properties such as, for example, wear resistance, insulation, and anti-slip features. By having the anodized coating layer ACL, an upper surface of the stage ST may prevent or reduce damage even when the display device DD is repeatedly processed on it. In addition, the anodized coating layer ACL may prevent static electricity from being generated between the display device DD and the stage ST, thereby reducing damage to the display device DD and preventing movement of the display device DD during a process.

The display device DD, which is a target of the UV light UV emitted by the curing device UVH, may be disposed on the stage ST. The ink INK may be disposed on one side of the display device DD. The ink INK may include a first ink INK1, a second ink INK2, and a third ink INK3.

For example, the ink INK may be light-blocking ink that prevents light leakage. The ink INK, disposed on one side of the display device DD, may block light emitted by the peripheral area of the display device DD. However, embodiments of the present disclosure are not limited thereto.

The ink INK may be cured by the UV light UV. An embodiment in which the ink INK is cured by the UV light UV will be described further below with reference to FIG. 4.

In an embodiment, as shown in FIG. 2, the first ink INK1, the second ink INK2, and the third ink INK3 may be spaced apart from each other. The first ink INK1, the second ink INK2, and the third ink INK3 may be disposed on different sides of the display device DD.

For example, the first ink INK1 may be disposed on a side of the display device DD facing an opposite direction of the third direction D3. The second ink INK2 may be disposed on a side facing an opposite direction of the second direction D2. The third ink INK3 may be disposed on a side facing the second direction D2.

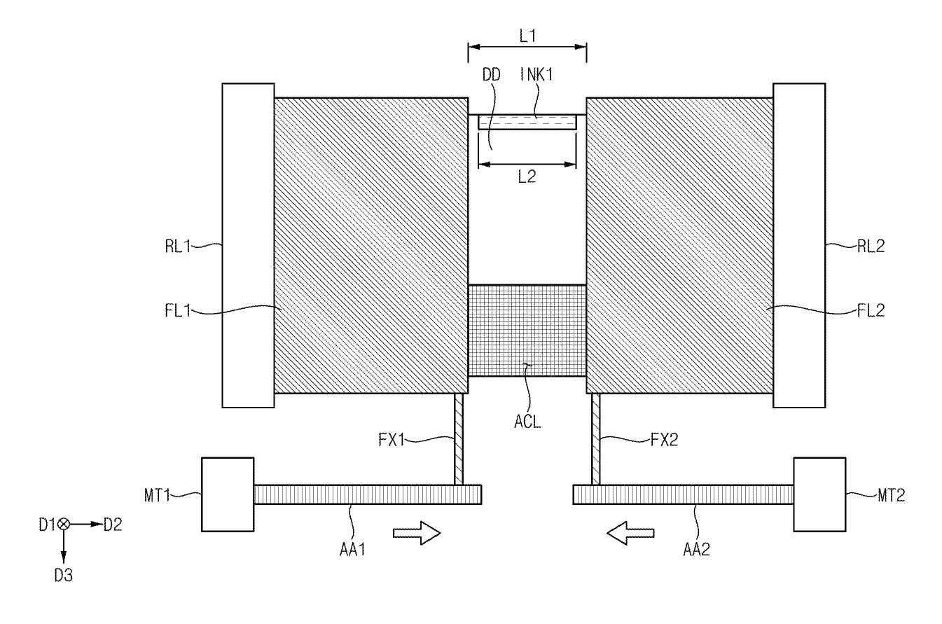

FIG. 4 is a perspective view showing an embodiment in which the first and second films are expanded in the curing apparatus of FIG. 2. FIG. 5 is a plan view showing an embodiment of the curing apparatus of FIG. 4. For example, FIGS. 4 and 5 show an embodiment in which the first film FL1 and the second film FL2 are expanded to block part of the UV light UV.

An embodiment described with reference to FIGS. 4 and 5 may be substantially same as configurations of FIGS. 2 and 3, except that the first film FL1 and the second film FL2 are expanded. Thus, for convenience of explanation, a further description of components and technical aspects previously described may be omitted.

Referring to FIGS. 2, 3, 4, and FIG. 5, the first film FL1 may be expanded in the second direction D2, and the second film FL2 may be expanded in a direction opposite to the second direction D2. As the first film FL1 and the second film FL2 are expanded, part of the UV light UV emitted by the curing device UVH in the first direction D1 may be blocked by the first film FL1 and the second film FL2. That is, the UV light UV emitted in the first direction D1 from the curing device UVH may be blocked by the first film FL1 and the second film FL2, and only part of the UV light UV may reach the display device DD.

For example, referring to FIGS. 2, 3, 4, and FIG. 5, according to embodiments of the present disclosure, the first film FL1 and the second film FL2 may be extended in opposite directions along the second direction D2. For example, the first film FL1 may be extended toward the second direction D2 by the first actuator AA1 of the first motor MT1, and the second film FL2 may be extended in a direction opposite to the second direction D2 by the second actuator AA2 of the second motor MT2. As these films are expanded, they move away from each other in opposite directions, creating a controlled gap between them through which the UV light UV may pass.

The curing device UVH emits the UV light UV in the first direction D1, which is directed downward toward the display device DD. As shown in FIG. 4, the expanded first and second films FL1 and FL2 are disposed between the curing device UVH and the display device DD and function as UV-blocking barriers. These films block peripheral portions of the emitted UV light UV, allowing only a central portion of the UV light UV to reach the display device DD. In this way, the first film FL1 and the second film FL2 define a selective exposure window that limits the area irradiated with UV light.

As further illustrated in FIG. 5, the spacing between the first film FL1 and the second film FL2 defines a first length L1, which corresponds to the exposed curing region. The UV light UV passing through this region may irradiate and cure an ink pattern INK1 disposed on the display device DD. By blocking UV light UV outside this region, the curing device UVH may prevent unintended UV exposure to adjacent components, such as the stage ST or areas of the display device DD not intended to be cured. This selective curing may improve processing precision and reduce potential damage to non-targeted areas.

In an embodiment, the first film FL1 may be connected to the first fixing portion FX1, which is connected to the first actuator AA1, and be expanded in the second direction D2. The second film FL2 may be connected to the second fixing portion FX2, which is connected to the second actuator AA2, and be expanded in a direction opposite to the second direction D2.

The first fixing portion FX1 and the second fixing portion FX2 may be, for example, a mechanical connector, bracket, clamp, or engagement structure that physically couples the first and second films FL1 and FL2 to their respective actuators AA1 and AA2. For example, each of the fixing portions FX1 and FX2 may include a slotted channel, an insertion groove, a hook structure, or a tensioned fitting that allows one end of the first and second films FL1 and FL2 to be secured while permitting linear movement in the second direction D2. Each fixing portion FL1, FL2 may be fixedly attached to its respective actuator AA1, AA2 and configured to transmit force generated by the respective actuator AA1, AA2 to the respective film FL1, FL2, enabling expansion or retraction of the film FL1, FL2 in response to actuator movement. The structure and material of the fixing portion may vary depending on the required tension, stiffness, and mechanical durability, and embodiments are not limited to the examples described herein.

After the first film FL1 and the second film FL2 are expanded, as shown in FIG. 5, the first film FL1 and the second film FL2 may be spaced apart by a first length L1 in the second direction D2. Thus, the UV light UV emitted by the curing device UVH may pass through a defined area spaced apart by the first length L1.

In an embodiment, the first ink INK1 may have a second length L2 in the second direction D2. For example, the first length L1 may be greater than or substantially equal to the second length L2. Accordingly, the UV light UV passing through the defined area spaced by the first length L1 may selectively cure the first ink INK1.

In an embodiment, if the first length L1, which represents a spacing distance between the first film FL1 and the second film FL2, differs from a predetermined distance, the controller CTR may provide an alarm to a user of the curing apparatus CA. Accordingly, the user may adjust the first length L1 to control the curing apparatus CA such that the ink INK is selectively cured.

In an embodiment, the first film FL1 and the second film FL2 may be automatically expanded under control of the controller CTR (e.g., the controller of FIG. 1). For example, the controller CTR may drive the first motor MT1 and the second motor MT2, and the first motor MT1 and the second motor MT2 may expand the first film FL1 and the second film FL2, respectively. Referring to a comparative example, without the first motor MT1 and the second motor MT2, the first film FL1 and the second film FL2 would need to be manually expanded, which could increase processing time and reduce efficiency. However, since embodiments of the present disclosure utilize the first motor MT1 and the second motor MT2, the films may be expanded automatically. By enabling automatic film expansion through motor control, the curing apparatus CA may improve operational throughput and support consistent, repeatable positioning of the films for selective UV curing.

In addition, the controller CTR may measure the second length L2 of the ink INK and the first length L1, and adjust the first length L1 in real time. Thus, the amount of time taken for the films to be expanded and rewound may be reduced, leading to shorter processing times using the curing apparatus CA.

In an embodiment, expanding the first film FL1 and the second film FL2 may be performed within about 2 seconds. For example, expanding the first film FL1 and the second film FL2 may be performed within about 1.5 seconds. Referring to a comparative example, without the first motor MT1 and the second motor MT2, the time required to expand the first film FL1 and the second film FL2 to the first length L1 may be about 10 minutes or more. As a result, the automatic expanding by the first film FL1 and the second film FL2 may reduce the processing time by about 10 minutes or more in a comparative example.

In contrast, according to embodiments of the present disclosure, the first film FL1 may be expanded at a speed of about 90 mm/s to about 110 mm/s in the second direction D2. For example, the first film FL1 may be expanded at a speed of about 95 mm/s to about 105 mm/s. Similarly, the second film FL2 may be expanded in a direction opposite to the second direction D2 at a similar speed range.

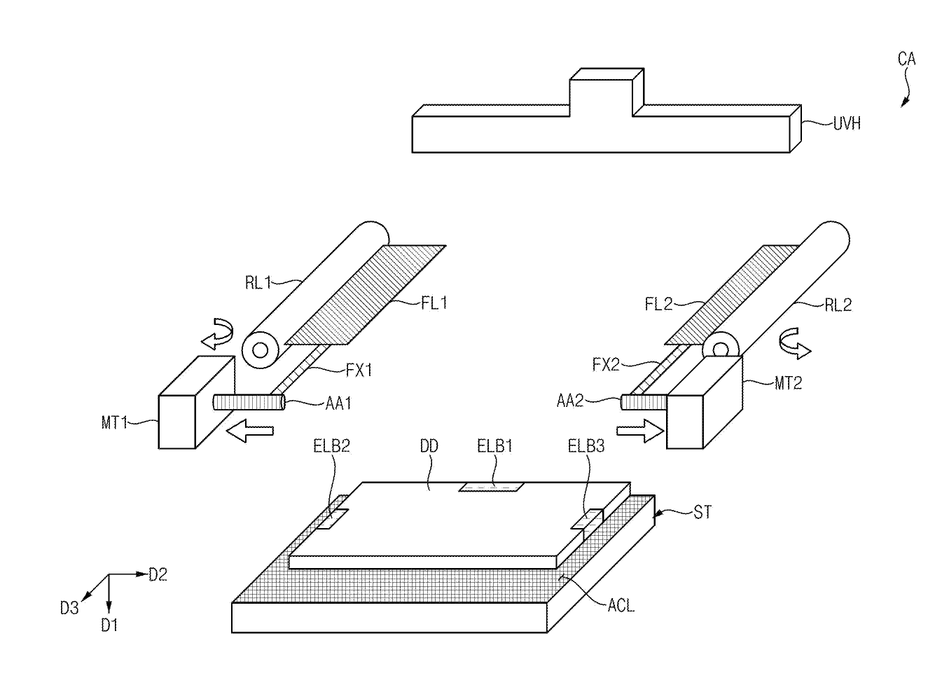

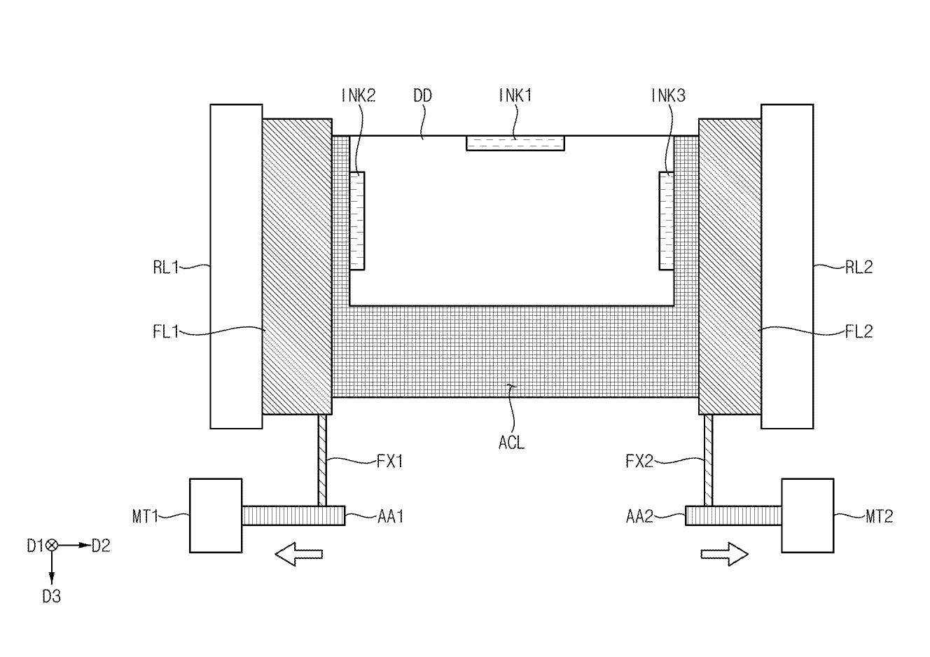

FIG. 6 is a perspective view showing an embodiment in which the first and second films are wound in the curing apparatus of FIG. 2. FIG. 7 is a plan view showing an embodiment of the curing apparatus of FIG. 6. The descriptions of FIGS. 6 and 7 are substantially the same as those of FIGS. 2, 3, 4, and FIG. 5, except that the first film FL1 and the second film FL2 are rewound onto the first reel RL1 and the second reel RL2, respectively. Thus, for convenience of explanation, a further description of components and technical aspects previously described may be omitted.

Referring to FIGS. 2, 3, 4, 5, 6, and FIG. 7, after curing is performed using the curing device UVH, the first film FL1 and the second film FL2 may be rewound onto the first reel RL1 and the second reel RL2, respectively. For example, the first film FL1 may be rewound inside the first reel RL1 by moving in a direction opposite to the second direction D2 by the first actuator AA1, and the second film FL2 may be rewound inside the second reel RL2 by moving in the second direction D2 by the second actuator AA2.

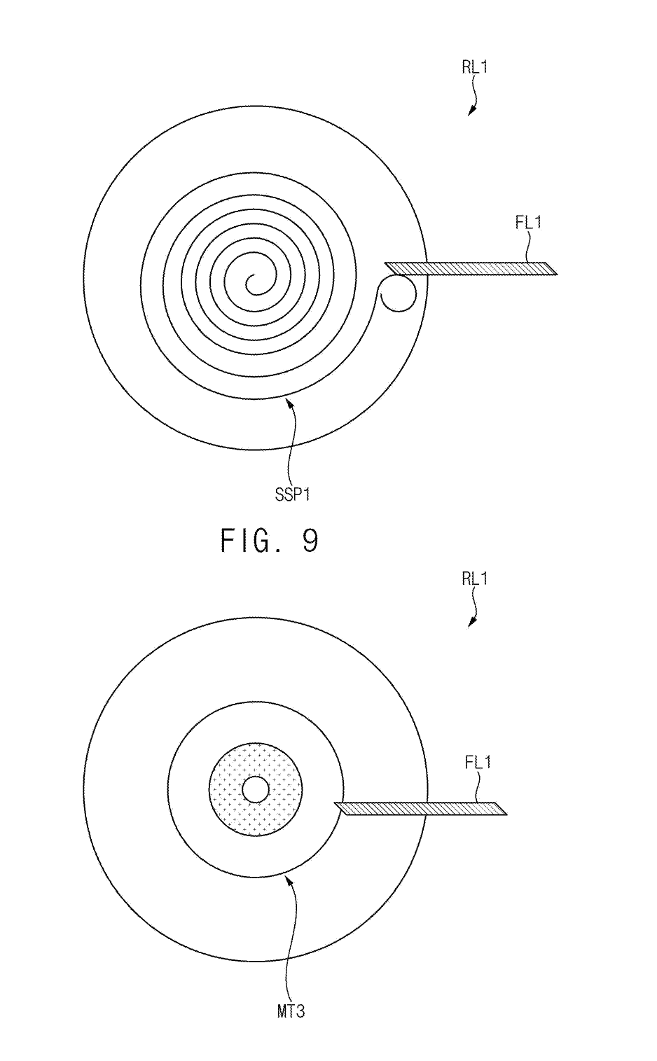

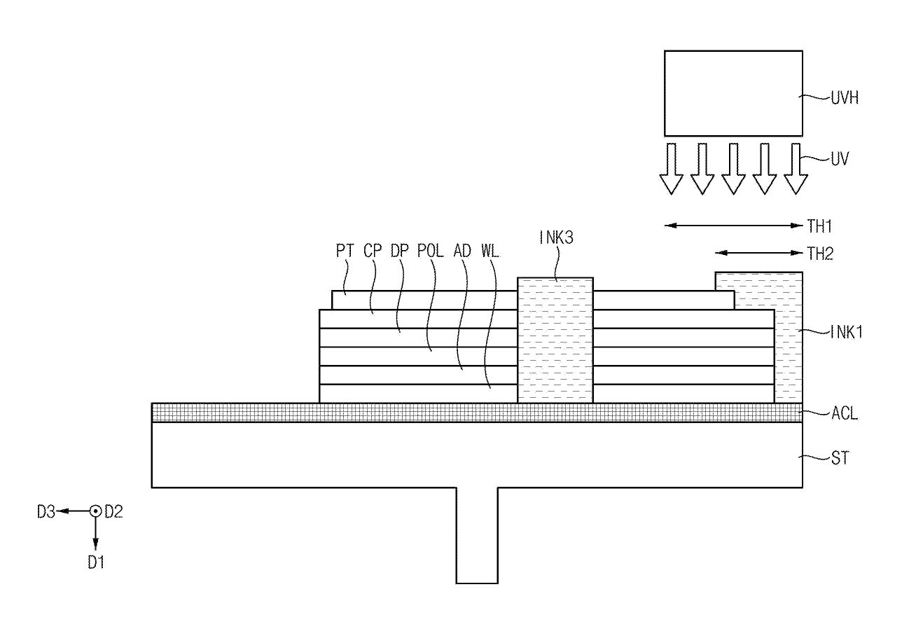

FIG. 8 is a cross-sectional view showing an embodiment of a first spiral spring disposed inside the first reel of FIG. 2. FIG. 9 is a cross-sectional view showing an embodiment of a third motor disposed inside the first reel of FIG. 2.

In FIG. 8, a first spiral spring SSP1 is shown disposed inside the first reel RL1. In FIG. 9, a third motor MT3 is shown disposed inside the first reel RL1. The second reel RL2 may also have a second spiral spring or a fourth motor disposed similarly to the components inside the first reel RL1. The following descriptions focus on the cross-sectional structure of the first reel RL1.

Referring to FIGS. 4, 6, and FIG. 8, the first spiral spring SSP1 may be disposed inside the first reel RL1. the first spiral spring SSP1 may be disposed inside the first reel RL1 in a coiled form in cross-sectional view. Accordingly, the first spiral spring SSP1 may pull the first film FL1 in a direction opposite to the second direction D2. For example, the first spiral spring SSP1 may include elastic metal materials, which may be used individually or in combination.

In an embodiment, as shown in FIG. 4, a force applied by the first motor MT1 to pull the first film FL1 in the second direction D2 may be greater than a force applied by the first spiral spring SSP1 to pull the first film FL1 in a direction opposite to the second direction D2. Thus, the first film FL1 may be expanded in the second direction D2.

Then, as the first actuator AA1 of the first motor MT1 moves in a direction opposite to the second direction D2, the first film FL1 may be rewound inside the first reel RL1 by the first spiral spring SSP1.

In an embodiment, when the first film FL1 is expanded in the second direction D2, the first spiral spring SSP1 may rotate counterclockwise in a cross-sectional view. When the first film FL1 is rewound in a direction opposite to the second direction D2, the first spiral spring SSP1 may rotate clockwise in cross-sectional view.

Referring further to FIGS. 6 and 9, the third motor MT3 may be disposed inside the first reel RL1. The first film FL1 may be rewound inside the first reel RL1 by the third motor MT3, which pulls the first film FL1 in a direction opposite to the second direction D2. Accordingly, the first film FL1 may be wound circularly inside the first reel RL1 in cross-sectional view by the third motor MT3.

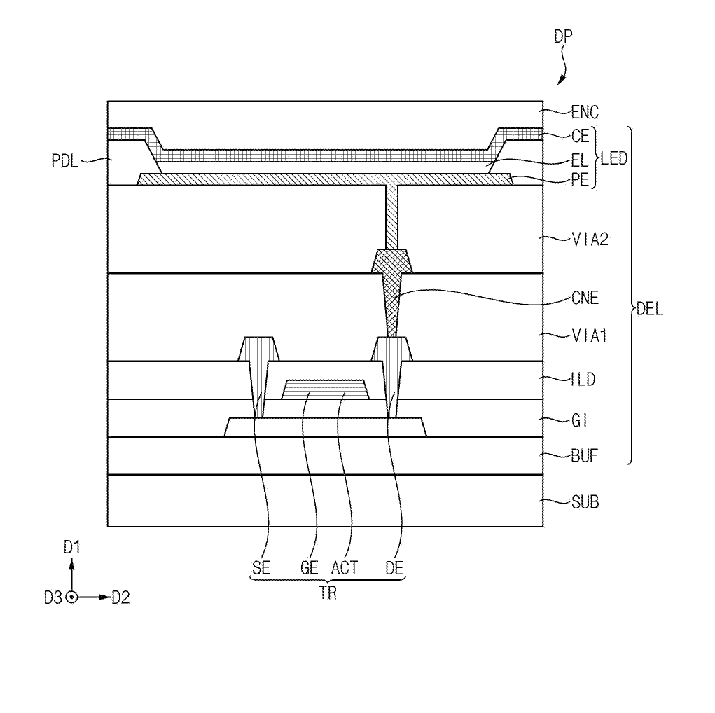

FIG. 10 is a cross-sectional view showing an embodiment of curing ink through the curing device of FIG. 4.

Referring to FIGS. 4 and 10, the display device DD may be disposed on the anodized coating layer ACL of the stage ST. The display device DD may include a plate PT, a cover panel CP, a display panel DP, a polarizing layer POL, an adhesive member AD, and a window layer WL sequentially arranged.

The plate PT may be disposed on a rear side of the display device DD and may prevent the display panel DP from bending due to external forces. The plate PT may include rigid or semi-rigid materials such as, for example, iron, chromium, carbon, nickel, silicon, manganese, or molybdenum. These materials may be used individually or in combination. However, embodiments of the present disclosure are not limited thereto. In an embodiment, the plate PT may be omitted.

The cover panel CP may be disposed on the plate PT. The cover panel CP may protect the display panel DP from external impact or foreign material ingress. The cover panel CP may include multiple layers.

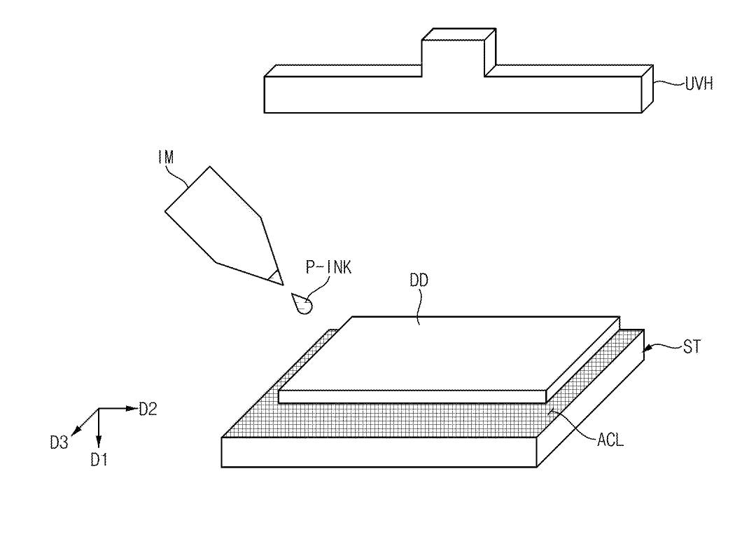

The display panel DP may be disposed on the cover panel CP and generate light based on input signals. Accordingly, the display panel DP may provide visual images to a user of the display device DD. The display panel DP will be described in further detail below with reference to FIG. 11.

The polarizing layer POL may be disposed on the display panel DP. The polarizing layer POL may reduce external light reflection on the display device DD. Accordingly, the polarizing layer POL may enhance display quality of the display device DD.

The adhesive member AD may be disposed on the polarizing layer POL. The adhesive member AD may adhere the polarizing layer POL and the window layer WL. The adhesive member AD may include at least one of, for example, an optically transparent resin (OCR), an optically transparent adhesive (OCA), a double-sided tape, and a pressure-sensitive adhesive (PSA). These may be used alone or in combination. However, embodiments of the present disclosure are not limited thereto.

The window layer WL may be disposed on an upper surface of the display device DD. In an embodiment, the window layer WL may be ultrathin glass (UTG). For example, the window layer WL may include soda-lime glass, alkali aluminosilicate glass, borosilicate glass, lithium aluminosilicate glass, etc. These may be used alone or in combination. However, the window layer WL according to embodiments of the present disclosure are not limited thereto, and may include various materials such as, for example, plastic.

In an embodiment, the display device DD may be disposed on the stage ST with the window layer WL in contact with the anodized coating layer ACL, as illustrated in FIG. 10. That is, the display device DD may be disposed such that the window layer WL, which is a front surface of the display device DD, is close to an upper surface of the stage ST. Each of the first ink INK1 and the third ink INK3 of the ink INK may cover at least a portion of an upper surface of the plate PT and may cover a portion of a side surface of the display device DD. The second ink (for example, the second ink INK2 of FIG. 4) may also cover at least a portion of an upper surface of the plate PT and may cover a portion of the side surface of the display device DD.

In an embodiment, an area where the UV light UV emitted by the curing device UVH illuminates the display device DD may have a first width TH1 as illustrated in FIG. 10. The first width TH1 may be about 10 mm or less. For example, the first width TH1 may be about 1 mm or more and about 10 mm or less.

The first ink INK1 may have a second width TH2 in the third direction D3. For example, the first width TH1 may be greater than or substantially equal to the second width TH2. Since the first width TH1 has a width greater than the second width TH2, the curing device UVH may entirely cure the ink INK in a plan view. The second ink INK2 and the third ink INK3 may also have a width substantially same as the second width TH2.

For example, according to an embodiment, the first ink INK1 may have a second width TH2 measured along the third direction D3. The UV light UV emitted by the curing device UVH may define a first width TH1 in the same direction. In an example, the first width TH1 may be greater than or substantially equal to the second width TH2. Accordingly, because the exposure width TH1 is wide enough to cover the width TH2 of the ink pattern INK1, the curing device UVH can irradiate and fully cure the entire area of the ink in a plan view. The second ink INK2 and the third ink INK3 may also have a width that is substantially the same as the second width TH2.

FIG. 11 is a cross-sectional view showing an embodiment of the display panel of FIG. 10.

Referring to FIGS. 10 and 11, the display panel DP may include a substrate SUB, a display element layer DEL, and an encapsulation layer ENC. The display element layer DEL may include a buffer layer BUF, a gate insulating layer GI, a transistor TR, an interlayer insulating layer ILD, a connection electrode CNE, a first via layer VIA1, a second via layer VIA2, a light-emitting diode LED, and a pixel defining layer PDL.

The transistor TR may include an active layer ACT, a gate electrode GE, a source electrode SE, and a drain electrode DE. The light-emitting diode LED may include a pixel electrode PE, a light emitting layer EL, and a common electrode CE.

The substrate SUB may include, for example, a glass substrate, a metal substrate, or a plastic substrate. However, embodiments of the present disclosure are not limited thereto, and the substrate SUB may include, for example, an inorganic layer, an organic layer, or a composite material layer.

The buffer layer BUF may be disposed on the substrate SUB. The buffer layer BUF may prevent impurities such, for example, as oxygen, moisture, etc. from penetrating into an upper portion of the substrate SUB through the substrate SUB. The buffer layer BUF may include an inorganic insulating material.

The active layer ACT may be disposed on the buffer layer BUF. The active layer ACT may include, for example, an oxide semiconductor, a silicon semiconductor, an organic semiconductor, etc. For example, the oxide semiconductor may include at least one oxide of indium (In), gallium (Ga), tin (Sn), zirconium (Zr), vanadium (V), hafnium (Hf), cadmium (Cd), germanium GE, chromium (Cr), titanium (Ti), and zinc (Zn). The silicon semiconductor may include, for example, amorphous silicon, polycrystalline silicon, etc. The active layer ACT may include a source region, a drain region, and a channel region positioned between the source region and the drain region.

A gate insulating layer GI may be disposed on the buffer layer BUF. A gate insulating layer GI may cover the active layer ACT on the buffer layer BUF. The gate insulating layer GI may include an inorganic insulating material. In an embodiment, the gate insulating layer GI may be disposed only under the gate electrode GE.

The gate electrode GE may be disposed on the gate insulating layer GI. The gate electrode GE may overlap at least a portion of the channel region of the active layer ACT. The gate electrode GE may include a conductive material such as, for example, a metal, an alloy, a conductive metal nitride, a conductive metal oxide, or a transparent conductive material. Examples of the conductive material that may be used for the gate electrode GE include gold (Au), silver (Ag), aluminum (Al), platinum (Pt), nickel (Ni), titanium (Ti), palladium (Pd), magnesium (Mg), calcium (Ca), lithium (Li), chromium (Cr), tantalum (Ta), tungsten (W), copper (Cu), molybdenum (Mo), scandium (Sc), neodymium (Nd), iridium (Ir), an alloy containing aluminum, an alloy containing silver, an alloy containing copper, an alloy containing molybdenum, aluminum nitride (AlN), tungsten nitride (WN), titanium nitride (TiN), chromium nitride (CrN), tantalum nitride (TaN), strontium ruthenium oxide (SrRuO), zinc oxide (ZnO), indium tin oxide (ITO), tin oxide (SnO), indium oxide (InO), gallium oxide (GaO), indium zinc. oxide (IZO), etc. These may be used alone or in combination with each other. In embodiments, the gate electrode GE may have a single-layer structure or a multi-layer structure including a plurality of conductive layers.

The interlayer insulating layer ILD may be disposed on the gate electrode GE. For example, the interlayer insulating layer ILD may be disposed on the gate insulating layer GI and may cover the gate electrode GE on the gate insulating layer GI. The interlayer insulating layer ILD may include an inorganic insulating material.

The source electrode SE and the drain electrode DE may be disposed on the interlayer insulating layer ILD. The source electrode SE and the drain electrode DE may be connected to the active layer ACT, respectively. For example, the source electrode SE may be in contact with the source region of the active layer ACT, and the drain electrode DE may be in contact with the drain region of the active layer ACT. Each of the source electrode SE and the drain electrode DE may include a conductive material. The above active layer ACT, the gate electrode GE, the source electrode SE, and the drain electrode DE form the transistor TR.

The first via layer VIA1 may be disposed on the source electrode SE and the drain electrode DE. For example, the first via layer VIA1 may be disposed on the interlayer insulating layer ILD and may cover the source electrode SE and the drain electrode DE on the interlayer insulating layer ILD. The first via layer VIA1 may include an organic insulating material.

The connection electrode CNE may be disposed on the first via layer VIA1. The connection electrode CNE may transmit a signal transmitted from the transistor TR to the light-emitting diode LED. The connection electrode CNE may include, for example, a metal, an alloy, a metal nitride, a conductive metal oxide, a transparent conductive material, or the like. These may be used alone or in combination with each other. However, embodiments of the present disclosure are not limited thereto.

The second via layer VIA2 may be disposed on the connection electrode CNE. For example, the second via layer VIA2 may be disposed on the first via layer VIA1 and may cover the connection electrode CNE. The second via layer VIA2 may include substantially the same material as the first via layer VIA1.

The pixel electrode PE may be disposed on the second via layer VIA2. The pixel electrode PE may include a conductive material. The pixel electrode PE may be connected to the drain electrode DE through the connection electrode CNE. Accordingly, the pixel electrode PE may be electrically connected to the transistor TR.

The pixel defining layer PDL may be disposed on the pixel electrode PE. For example, the pixel defining layer PDL may expose at least a portion of the pixel electrode PE. The pixel defining layer PDL may include an inorganic insulating material or an organic insulating material.

The light-emitting layer EL may be disposed on the pixel electrode PE. In an embodiment, the light-emitting layer EL may be disposed within an opening defined by the pixel defining layer PDL. That is, the light-emitting layer EL may be surrounded by the pixel defining layer PDL. In an embodiment, the light-emitting layer EL may also be disposed on the pixel defining layer PDL. The light-emitting layer EL may include at least one of an organic light-emitting material and/or a quantum dot. However, embodiments of the present disclosure are not limited thereto.

The common electrode CE may be disposed on the light-emitting layer EL. The common electrode CE may also be disposed on the pixel-defining layer PDL. That is, the common electrode CE may be disposed continuously on the light-emitting layer EL and the pixel-defining layer PDL. The common electrode CE may include a conductive material. The light-emitting layer EL may emit light based on a voltage difference between the pixel electrode PE and the common electrode CE.

The encapsulation layer ENC may be disposed on the common electrode CE. The encapsulation layer ENC may include at least one inorganic encapsulation layer and at least one organic encapsulation layer. In an embodiment, the inorganic encapsulation layer and the organic encapsulation layer may be arranged alternately. For example, the organic encapsulation layer may include a polymer cured material such as polyacrylate, epoxy resin, silicone resin, etc. For example, the inorganic encapsulating layer may include silicon oxide, silicon nitride, silicon carbide, aluminum oxide, tantalum oxide, hafnium oxide, zirconium oxide, titanium oxide, and the like.

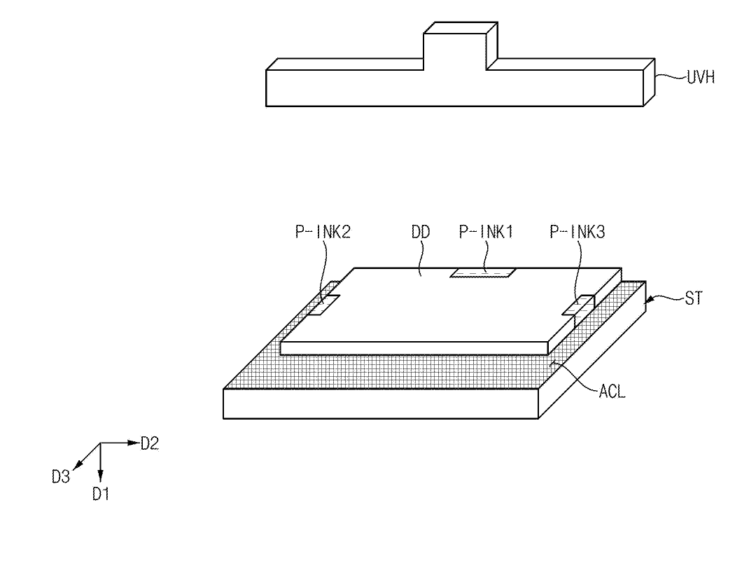

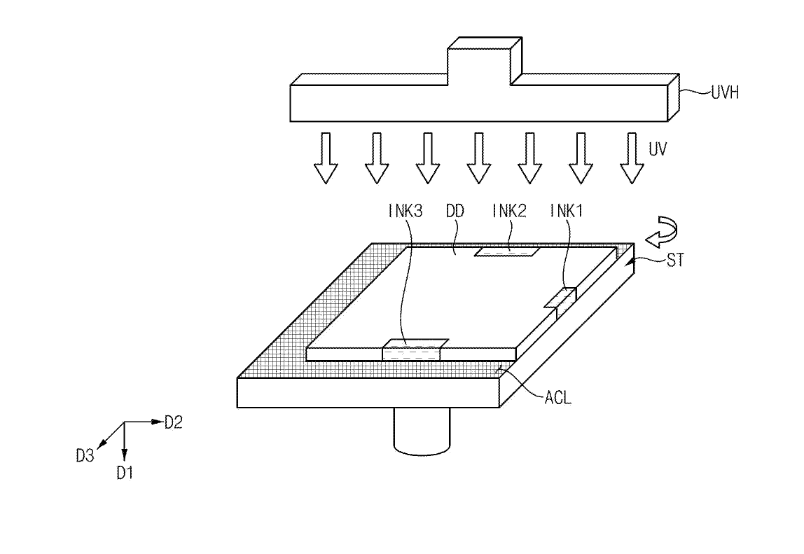

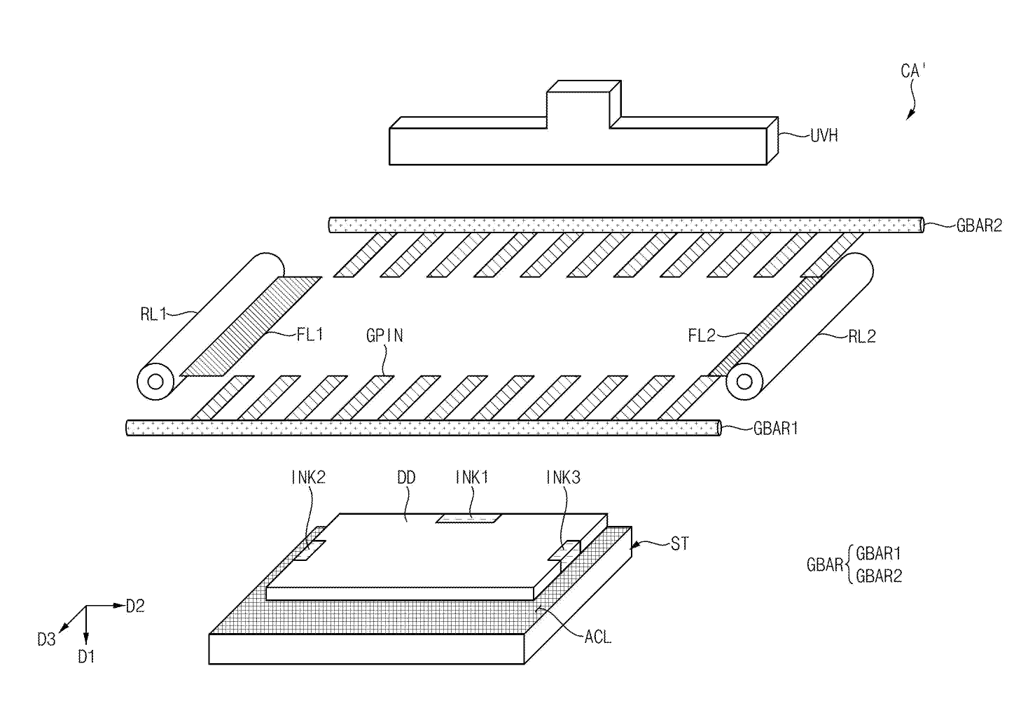

FIGS. 12, 13, 14, and FIG. 15 are views showing a method of curing using the curing apparatus according to embodiments of the present disclosure. For convenience of illustration, the first film FL1 and the second film FL2 are not illustrated in FIGS. 14 and 15, and it is to be understood that the curing method described with reference FIGS. 14 and 15 may still involve expanding the first and second films FL1 and FL2 to selectively block the UV light UV, as previously illustrated and described with reference to FIGS. 4 and 5..

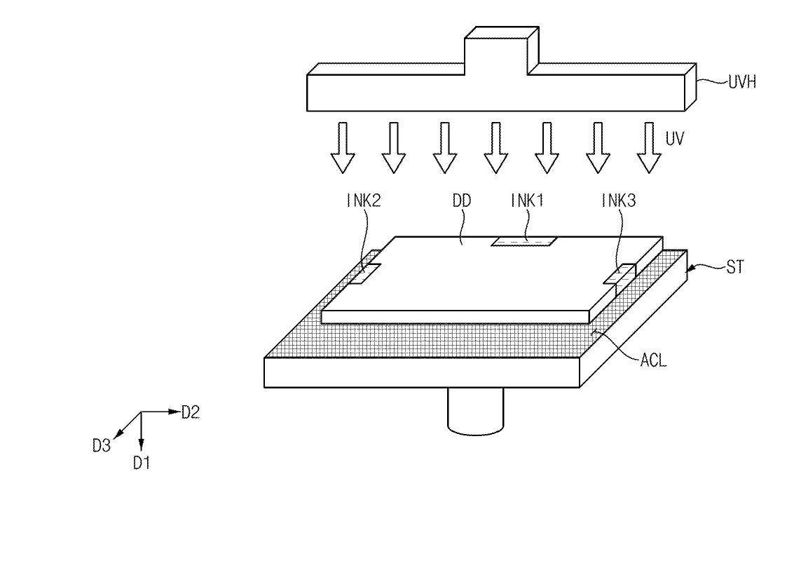

Referring to FIGS. 12 and 13, the ink module IM may apply a preliminary ink P-INK to one side of the display device DD disposed on the stage ST. The preliminary ink P-INK may be formed in three locations on the display device DD.

For example, as shown in FIG. 13, a first preliminary ink P-INK1 may be formed on a side of the display device DD facing a direction opposite to the third direction D3. A second preliminary ink P-INK2 may be formed on a side of the display device DD facing a direction opposite to the second direction D2. A third preliminary ink P-INK3 may be formed on a side of the display device DD facing the second direction D2. However, embodiments of the present disclosure are not limited thereto. For example, according to embodiments, the ink INK may be formed in two or fewer, or four or more locations on the sides of the display device DD.

Referring further to FIGS. 2, 3, 4, 5, and FIG. 14, as the first film FL1 and the second film FL2 may block part of the UV light UV emitted by the curing device UVH, the UV light UV may selectively cure the first ink INK1. For example, the first film FL1 may block a first part of the UV light UV emitted by the curing device UVH, and the second film FL2 may block a second part of the UV light UV emitted by the curing device UVH. Although the first film FL1 and the second film FL2 are not shown in FIG. 14, when curing the preliminary ink P-INK using the curing device UVH, as shown in FIG. 5, the first film FL1 and the second film FL2 may block part of the UV light UV.

If the first film FL1 and the second film FL2 shown in FIG. 5 do not block the UV light UV, the UV light UV emitted by the curing device UVH may reach the anodized coating layer ACL. When the anodized coating layer ACL is continuously exposed to the UV light UV, the anodized coating layer ACL may be damaged by the UV light UV. As a result, when the display device DD is disposed on the stage ST, a curvature may form on an upper surface of the anodized coating layer ACL, and the display device DD may not be disposed at a predetermined position on the stage ST.

Consequently, by blocking part of the UV light UV and selectively curing the first ink INK1, the first film FL1 and the second film FL2 may prevent or reduce damage to the anodized coating layer ACL disposed on the stage ST.

In an embodiment, the first preliminary ink P-INK1, the second preliminary ink P-INK2, and the third preliminary ink P-INK3 may be cured by the UV light UV emitted by the curing device UVH. As the first preliminary ink P-INK1, the second preliminary ink P-INK2, and the third preliminary ink P-INK3 are cured by the UV light UV, the first preliminary ink P-INK1, the second preliminary ink P-INK2, and the third preliminary ink P-INK3 may be formed as the first ink INK1, the second ink INK2, and the third ink INK3, respectively.

Referring further to FIGS. 4, 5, and FIG. 15, the stage ST may rotate in a clockwise direction. As the stage ST rotates clockwise, the UV light UV may cure the second ink INK2. For example, when the first film FL1 and the second film FL2 are in an expanded state and the stage ST rotates clockwise, the UV light UV emitted by the curing device UVH may selectively cure the second ink INK2. Accordingly, exposure to the UV light UV in areas other than the second ink INK2 may be reduced. As a result, damage to the anodized coating layer ACL may be prevented or reduced, and the second ink INK2 may be selectively cured. However, embodiments of the present disclosure are not limited thereto. For example, according to embodiments, the stage ST may also rotate counterclockwise, in which case the UV light UV may selectively cure the third ink INK3.

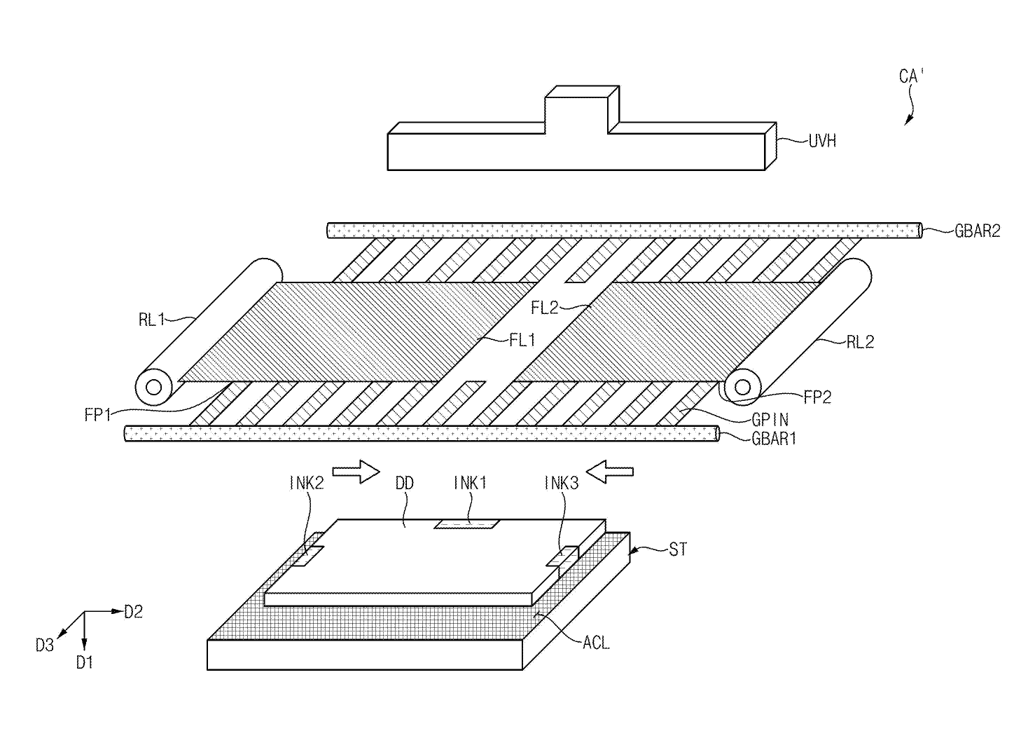

FIG. 16 is a perspective view showing a curing apparatus according to an embodiment of the present disclosure. FIG. 17 is a perspective view showing an embodiment in which the first and second films are expanded in the curing apparatus of FIG. 15.

Descriptions referring to FIGS. 16 and 17 may be substantially same as those referring to FIG. 2, except for a guide bar GBAR and a guide pin GPIN. Therefore, for convenience of explanation, a further description of components and technical aspects previously described may be omitted.

Referring to FIGS. 2, 16, and FIG. 17, the curing apparatus CA' may include the guide bar GBAR and the guide pin GPIN.

The guide bar GBAR may include a first guide bar GBAR1 and a second guide bar GBAR2. Each of the first guide bar GBAR1 and the second guide bar GBAR2 may have a bar shape extending in the second direction D2. However, embodiments of the present disclosure are not limited thereto.

The guide pin GPIN may be disposed on each of the first guide bar GBAR1 and the second guide bar GBAR2. The guide pin GPIN may be disposed at a predetermined interval on each of the first guide bar GBAR1 and the second guide bar GBAR2. The guide pin GPIN may be connected to the first film FL1 and the second film FL2. That is, the guide pin GPIN may include a fastening portion, a fastening groove, etc. at one end so as to be connected to the first film FL1 and the second film FL2. For example, the guide pin GPIN may include a first fastening portion FP1 attached to the first film FL1 and a second fastening portion FP2 attached to the second film FL2. Embodiments of the present application may include a plurality of guide pins GPIN, each having a first fastening portion and a second fastening portion.

The first film FL1 and the second film FL2 may be manually connected to the guide pin GPIN. That is, a user of the curing device CA’ may manually connect the first film FL1 and the second film FL2 to the guide pin GPIN. However, since the guide pins GPIN are pre-arranged on the guide bar GBAR at regular intervals, the user of the curing device CA’ may connect the first film FL1 and the second film FL2 to the guide pins GPIN within about 1 minute.

In an embodiment, the first film FL1 may be fixed to the guide pin GPIN so as to be fixed to the guide pin GPIN after being expanded in the second direction D2. The second film FL2 may be fixed to the guide pin GPIN after being expanded in a direction opposite to the second direction D2. When the first film FL1 and the second film FL2 are fixed to the guide pin GPIN, a part of the UV light UV emitted by the curing device UVH may be blocked. That is, as in FIG. 4, the first film FL1 and the second film FL2 may be fixed by the guide pin GPIN so as to block a part of the UV light UV.

According to embodiments, the guide pin GPIN may be formed as a protruding structure integrally formed with or attached to the guide bars GBAR1 and GBAR2, and may include, for example, a groove, hook, latch, or other fastening feature that engages a hole or loop formed at an edge of the first and second films FL1, FL2. The connection may be reversible or fixed, and the spacing of the guide pins GPIN may allow the user to select a desired exposure width without much manual effort.

Accordingly, the UV light (for example, the UV light UV of FIG. 4) emitted by the curing unit UVH may selectively cure the ink INK. As a result, the first film FL1 and the second film FL2 may block the UV light (for example, the UV light UV of FIG. 4) to prevent or reduce damage to the anodized coating layer ACL. In addition, by fixing the first film FL1 and the second film FL2 through the guide pin GPIN attached to the guide bar GBAR, a process time of curing the ink INK may be shortened.

While the present disclosure has been particularly shown and described with reference to embodiments thereof, it will be understood by those of ordinary skill in the art that various changes in form and detail may be made therein without departing from the spirit and scope of the present disclosure as defined by the following claims.

What is claimed is:

1. A curing apparatus, comprising:
a curing device configured to emit an ultraviolet (UV) light in a first direction;
a first film disposed under the curing device and configured to block a first part of the UV light emitted by the curing device;
a second film disposed under the curing device, configured to block a second part of the UV light emitted by the curing device, and spaced apart from the first film in a second direction intersecting the first direction;
a first motor configured to move the first film in the second direction; and
a second motor configured to move the second film in a direction opposite to the second direction.

2. The curing apparatus of claim 1, further comprising:
a first reel connected to the first film; and
a second reel connected to the second film.

3. The curing apparatus of claim 2, further comprising:
a first spiral spring disposed inside the first reel and configured to pull the first film in the direction opposite to the second direction; and
a second spiral spring disposed inside the second reel and configured to pull the second film in the second direction.

4. The curing apparatus of claim 2, further comprising:
a third motor disposed inside the first reel and configured to pull the first film in the direction opposite to the second direction; and
a fourth motor disposed inside the second reel and configured to pull the second film in the second direction.

5. The curing apparatus of claim 1, wherein the first motor includes a first actuator extending in the second direction, and
the second motor includes a second actuator extending in the direction opposite to the second direction.

6. The curing apparatus of claim 5, wherein one end of the first film is connected to the first actuator with a first fixing portion, and
one end of the second film is connected to the second actuator with a second fixing portion.

7. The curing apparatus of claim 6, further comprising:
a first reel connected to the first film; and
a second reel connected to the second film,
wherein another end of the first film, opposite to the one end of the first film, is wound on the first reel, and
another end of the second film, opposite to the one end of the second film, is wound on the second reel.

8. The curing apparatus of claim 1, wherein a wavelength of the UV light emitted by the curing device is between about 340 nm and about 390 nm.

9. The curing apparatus of claim 1, wherein each of the first film and the second film includes polyethylene terephthalate (PET).

10. The curing apparatus of claim 1, further comprising:
a stage disposed under the curing device and configured to accommodate a display device,
wherein an upper surface of the stage is coated with an anodized coating layer.

11. A curing apparatus, comprising:
a curing device configured to emit an ultraviolet (UV) light in a first direction;
a first film disposed under the curing device and configured to block a first part of the UV light emitted by the curing device;
a second film disposed under the curing device, configured to block a second part of the UV light emitted by the curing device, and spaced apart from the first film in a second direction intersecting the first direction; and
a guide bar extending in the second direction, and comprising a guide pin having a first fastening portion attached to the first film and a second fastening portion attached to the second film.

12. The curing apparatus of claim 11, further comprising:
a first reel connected to the first film; and
a second reel connected to the second film.

13. The curing apparatus of claim 12, further comprising:
a first spiral spring disposed inside the first reel and configured to pull the first film in a direction opposite to the second direction; and
a second spiral spring disposed inside the second reel and configured to pull the second film in the second direction.

14. The curing apparatus of claim 12, further comprising:
a first motor disposed inside the first reel and configured to pull the first film in a direction opposite to the second direction; and
a second motor disposed inside the second reel and configured to pull the second film in the second direction.

15. A method of curing ink, comprising:
applying the ink to one side of a display device disposed on a stage spaced apart from a curing device in a first direction;
expanding a first film in a second direction intersecting the first direction and expanding a second film in a direction opposite to the second direction; and
curing the ink by emitting an ultraviolet (UV) light in the first direction from the curing device.

16. The method of claim 15, wherein expanding the first film and the second film comprises:
expanding the first film, by a first actuator connected to the first film and extending in the second direction, under control of a first motor; and
expanding the second film, by a second actuator connected to the second film and extending in a direction opposite to the second direction, under control of a second motor.

17. The method of claim 15, wherein, during expanding the first film and the second film,
each of the first film and the second film is expanded at a speed between about 90 mm/s and about 110 mm/s.

18. The method of claim 15, wherein expanding the first film and the second film is performed within about 2 seconds.

19. The method of claim 15, wherein, after expanding the first film and the second film,
a first length corresponding to a minimum distance between the first film and the second film in the second direction is greater than a second length corresponding to a length of the ink applied to the display device along a major axis in the second direction.

20. The method of claim 19, further comprising:
providing an alarm to a user when a distance between the first film and the second film in the second direction differs from a predetermined distance.
